(19) United States
(12) Patent Application Publication
(10) Pub. No.: US 2022/0106886 A1
(43) Pub. Date: Apr. 7, 2022

(54) Gas Turbine Nozzle

(71) Applicant: Mitsubishi Power, Ltd., Yokohama-shi (JP)

(72) Inventors: Ryota NAKATA, Yokohama-shi (JP); Yasuhiro Horiuchi, Yokohama-shi (JP); Kunihiro Oga, Yokohama-shi (JP)

(21) Appl. No.: 17/449,998

(22) Filed: Oct. 5, 2021

(30) Foreign Application Priority Data
Oct. 6, 2020 (JP) 2020-169051

(51) Int. Cl. F01D 9/02; F01D 9/06

(52) U.S. Cl. CPC F01D 9/02; F05D 2240/128; F05D 2260/201; F01D 9/065

(57) ABSTRACT

The gas turbine nozzle has nozzles formed integrally through an inner endwall and an outer endwall. The inner endwall has an upstream connection portion, a downstream connection portion, and an inner endwall body. The upstream connection portion extends radially inward and is connected to the inner turbine diaphragm. The downstream connection portion is located downstream from the upstream connection portion, extends radially inward, and is connected to the inner turbine diaphragm. The inner endwall body extends from upstream toward downstream and the upstream connection portion and the downstream connection portion are formed on the inner endwall body. The inner endwall body has a digging area that is dug radially outward in a position between the upstream connection portion and the downstream connection portion, and an impingement cooling plate is installed on a surface of the digging area.

### CLAIM OF PRIORITY

The present application claims priority from Japanese Patent application serial no. 2020-169051, filed on Oct. 6, 2020, the content of which is hereby incorporated by reference into this application.

### BACKGROUND OF THE INVENTION

The present invention relates to a gas turbine nozzle and, more specifically, to a gas turbine nozzle of integrated nozzle structure in which two nozzles are formed integrally through an inner endwall and an outer endwall.

Conventional techniques in such technological field are described in, for example, Japanese Unexamined Patent Application Publication No. 2017-219042 which discloses a gas turbine nozzle of integrated nozzle structure (see FIG. 3 of the publication). Japanese Unexamined Patent Application Publication No. 2017-219042 describes a nozzle cooling system for a gas turbine engine that has an impingement plate (impingement cooling plate) positioned radially inwardly from a radially inner surface of an inner side wall of a nozzle (gas turbine nozzle) (see Abstract of the publication).

Japanese Unexamined Patent Application Publication No. 2017-219042 discloses the gas turbine nozzle of integrated nozzle structure.

On the gas turbine nozzles, in the future, the temperature of a gas turbine nozzle will increasingly rise during operation of the gas turbine. To cope with such rises in gas turbine nozzle temperature, additional gas turbine nozzle cooling is required for the gas turbine nozzle. When the gas turbine nozzle is cooled, it is necessary to reuse cooling air in order to cool the gas turbine nozzle with efficiency without an increase in cooling air.

However, Japanese Unexamined Patent Application Publication No. 2017-219042 presents no description on a gas turbine nozzle capable of being efficiently cooled. That is, it presents a description of the use of an impingement cooling plate to cool the gas turbine nozzle. However, it presents no description of the efficient use of cooling air in addition to the use of the impingement cooling plate to cool the gas turbine nozzle.

### SUMMARY OF THE INVENTION

Accordingly, it is an object of the present invention to provide a gas turbine nozzle using an impingement cooling plate and efficiently using cooling air.

To achieve this, the present invention provides a gas turbine nozzle with nozzles formed integrally through an inner endwall and an outer endwall. The inner endwall has an upstream connection portion, a downstream connection portion, and an inner endwall body. The upstream connection portion extends radially inward and is connected to the inner turbine diaphragm. The downstream connection portion is located downstream from the upstream connection portion, extends radially inward, and is connected to the inner turbine diaphragm. The inner endwall body extends from upstream toward downstream and the upstream connection portion and the downstream connection portion are formed on the inner endwall body.

Further, the inner endwall body has a digging area that is dug radially outward in a position between the upstream connection portion and the downstream connection portion, and an impingement cooling plate is installed on a surface of the digging area.

According to the present invention, the gas turbine nozzle is capable of using an impingement cooling plate and efficiently using cooling air.

These and other objects, features and advantages will be apparent from a reading of the following description of examples.

### BRIEF DESCRIPTION OF THE DRAWINGS

FIG. 1 is an explanatory schematic diagram illustrating a gas turbine 100 according to the examples;

FIG. 2 is an explanatory perspective view illustrating a gas turbine nozzle 10 according to the examples;

FIG. 3 is an explanatory sectional view illustrating the gas turbine nozzle 10 according to the examples;

FIG. 4 is an explanatory sectional view illustrating an inner endwall 3 according to the examples; and

FIG. 5 is an explanatory diagram schematically illustrating an installation position of an impingement cooling plate 35 according to the examples.

### DETAILED DESCRIPTION OF THE PREFERRED EMBODIMENTS

Examples according to the present invention will now be described. It is to be understood that like reference signs indicate substantially the same or similar configurations, which are not duplicated described and the description may be omitted.

### EXAMPLES

### Gas Turbine 100

Initially, a gas turbine 100 according to the example is described.

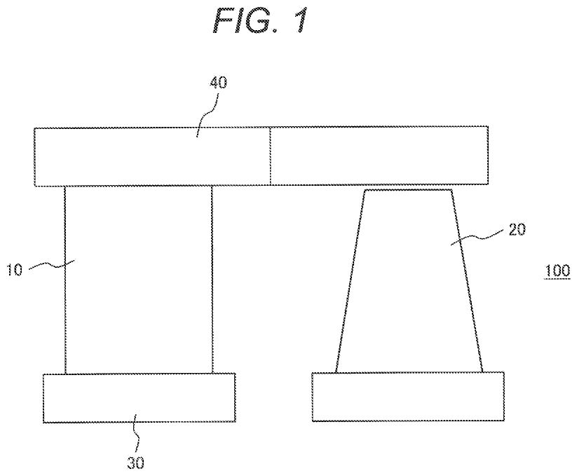

FIG. 1 is an explanatory schematic diagram illustrating the gas turbine 100 according to the example.

The gas turbine 100 has a gas turbine nozzle 10 and a gas turbine bucket 20, and introduces high temperature combustion gases.

The high temperature combustion gas is produced in a combustor (not shown) by burning air compressed at a compressor (not shown), and fuel fed into the combustor.

In the gas turbine 100, the high temperature combustion gases produced in the combustor are introduced into the gas turbine nozzle 10, and then, after passing through the gas turbine nozzle 10, the high temperature combustion gases are introduced into the gas turbine bucket 20.

The high temperature combustion gases thus introduced rotate the gas turbine bucket 20. In turn, the rotation of the gas turbine bucket 20 causes a generator (not shown) coaxially coupled to the gas turbine bucket 20 to generate electric power.

In this manner, the high temperature combustion gases produced in the combustor are introduced into the gas turbine nozzle 10.

As for the gas turbine nozzle 10, in the future, the temperature of the gas turbine nozzle 10 will increasingly rise during operation of the gas turbine 100. Accordingly, additional gas turbine nozzle cooling is required for the gas turbine nozzle 10. When the gas turbine nozzle 10 is cooled, it is necessary to cool the gas turbine nozzle 10 with efficiency by reusing cooling air without an increase in cooling air.

It is noted that the gas turbine nozzle 10 is connected on its inner perimeter side to an inner turbine diaphragm 30, and on its outer perimeter side to an outer turbine diaphragm 40.

### Gas Turbine Nozzle 10

The gas turbine nozzle 10 according to the example will now be described.

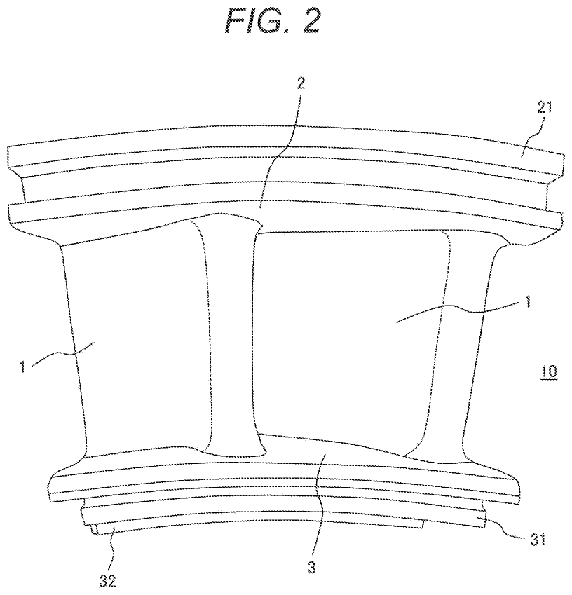

FIG. 2 is an explanatory perspective view illustrating the gas turbine nozzle 10 according to the example.

The gas turbine nozzle 10 according to the example is, in particular, a gas turbine nozzle 10 of integrated nozzle structure.

Specifically, in the gas turbine nozzle 10 of the integrated nozzle structure illustrated in the example, two nozzles 1 are formed integrally with an inner endwall 3 and an outer endwall 2 between the inner endwall 3 and the outer endwall 2.

Also, two nozzles 1 formed in the gas turbine nozzle 10 are formed such that rear edge portions of the nozzles 1 are offset in the circumferential direction with respect to front edge portions of the nozzles 1. This allows the high temperature combustion gases flowing through the gas turbine nozzle 10 to be introduced into the gas turbine bucket 20 with efficiency.

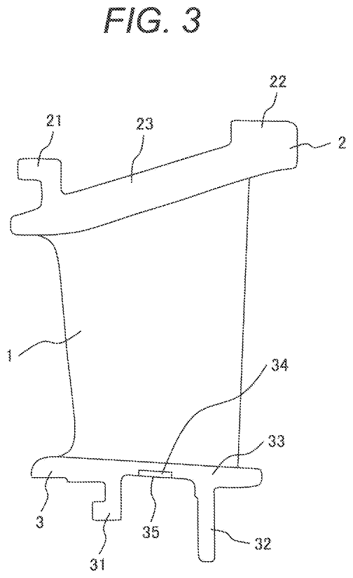

FIG. 3 is an explanatory sectional view illustrating the gas turbine nozzle 10 according to the example.

The gas turbine nozzle 10 has the nozzles 1, the outer endwall 2, and the inner endwall 3.

The outer endwall 2 has an upstream side hook 21, a downstream side hook 22, and an outer endwall body 23. The upstream side hook 21 extends radially outward and is connected to an outer turbine diaphragm 40. The downstream side hook 22 extends radially outward, and is located downstream from the upstream side hook 21, and connected to the outer turbine diaphragm 40. The outer endwall body 23 extends from upstream toward downstream and the upstream side hook 21 and the downstream side hook 22 are formed integrally with the outer endwall body 23.

The inner endwall 3 also has an upstream connection portion 31, a downstream connection portion 32, and an inner endwall body 33. The upstream connection portion 31 extends radially inward and is connected to the inner turbine diaphragm 30. The downstream connection portion 32 extends radially inward, and is located downstream from the upstream connection portion 31, and connected to the inner turbine diaphragm 30. The inner endwall body 33 extends from upstream toward downstream and the upstream connection portion 31 and the downstream connection portion 32 are formed on the inner endwall body 33.

Moreover, in the inner endwall body 33, a digging area 34 is formed between the upstream connection portion 31 and the downstream connection portion 32 by digging the inner endwall body 33 in the radially outward direction (from the inner turbine diaphragm 30 side (non-gas path side)), and an impingement cooling plate 35 is installed on the surface of the digging area 34.

For cooling the inner endwall 3, in particular, cooling is required to be provided for:
(1) a portion of the inner endwall body 33 from the front end portion (leading edge portion) of the inner endwall body 33 to a base portion between the inner endwall body 33 and the upstream connection portion 31 (the connection portion (joint between the inner endwall body 33 and the upstream connection portion 31);
(2) a portion of the inner endwall body 33 between the upstream connection portion 31 and the downstream connection portion 32 (inter-nozzle cooling); and
(3) a portion of the inner endwall body 33 downstream of the downstream connection portion 32 (to the rear end portion (trailing edge portion) of the inner endwall body 33) (downstream cooling).

For this purpose, the forgoing portions of the inner endwall body 33 are required to be cooled efficiently by reuse of cooling air without an increase in cooling air.

In the example, in the inner endwall body 33, the digging area 34 is formed between the upstream connection portion 31 and the downstream connection portion 32 by digging the inner endwall body 33 in the radially outward direction, and the impingement cooling plate 35 is installed on the surface of the digging area 34.

This enables efficient use of cooling air to cool the inner endwall body 33, that is, the gas turbine nozzle 10 with efficiency.

Especially, in the example, the digging area 34 is formed in the central portion (between the upstream connection portion 31 and the downstream connection portion 32) of the inner endwall 3 of the gas turbine nozzle 10 of the integrated nozzle structure in which two nozzles 1 are formed integrally through the inner endwall 3 and the outer endwall 2, and the impingement cooling plate 35 is installed on the digging area 34 thus formed.

This enables efficient use of cooling air to cool the inner endwall body 33, that is, the gas turbine nozzle 10 in an efficient and uniform manner without being affected by pressure gradient on the gas path side.

### Inner Endwall 3

The inner endwall 3 illustrated in the example will described below.

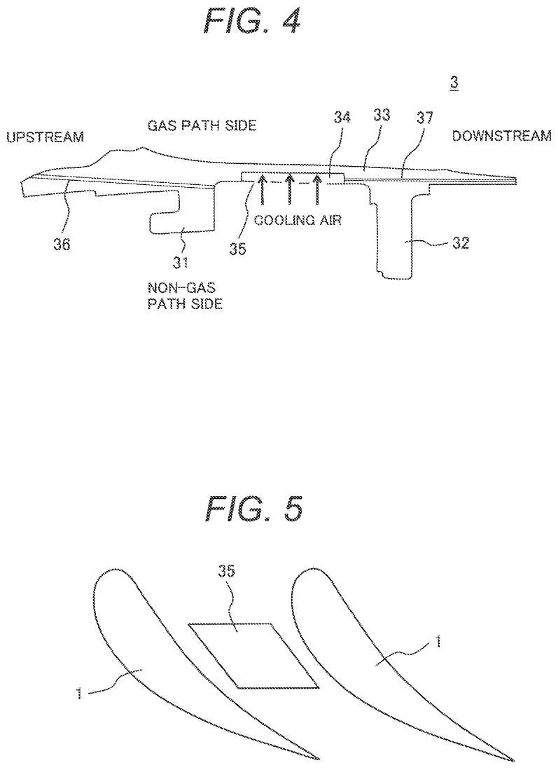

FIG. 4 is an explanatory sectional view illustrating the inner endwall 3 according to the example.

The inner endwall 3 has the upstream connection portion 31, the downstream connection portion 32, and the inner endwall body 33. The upstream connection portion 31 extends radially inward and is connected to the inner turbine diaphragm 30. The downstream connection portion 32 extends radially inward, and is located downstream from the upstream connection portion 31 and connected to the inner turbine diaphragm 30. The inner endwall body 33 extends from upstream toward downstream and the upstream connection portion 31 and the downstream connection portion 32 are formed on the inner endwall body 33.

In the inner endwall body 33, the digging area 34 is formed between the upstream connection portion 31 and the downstream connection portion 32 by digging the inner endwall body 33 in the radially outward direction. The impingement cooling plate 35 is installed on the surface of the digging area 34.

It is noted that the impingement cooling plate 35 has injection holes formed therein so that cooling air is vertically injected from the injection holes toward the bottom (in the radially outward direction) of the digging area 34 formed in the inner endwall body 33. It is preferable that the injection holes are formed in a staggered grid pattern.

In this way, the inner endwall body 33, i.e., the gas turbine nozzle 10 can be efficiently cooled.

The digging area 34 may be formed by cutting a central portion of the inner endwall body 33 (between the upstream connection portion 31 and the downstream connection portion 32) or may be molded together with the inner endwall body 33. The impingement cooling plate 35 is welded and installed to the inner endwall body 33 to cover the surface of the digging area 34.

It is noted that the digging area 34 is formed in the central portion of the inner endwall body 33, and the digging area 34 is formed with a space left for welding the impingement cooling plate 35 between the base portion of the upstream connection portion 31 and an edge of the digging area 34 and between the base portion of the downstream connection portion 32 and an edge of the digging area 34.

Also, the digging area 34 is formed by digging the central portion of the inner endwall body 33 to a depth approximately half of the thickness of the central portion of the inner endwall body 33 in the radial direction. That is, a radial depth of the digging area 34 is preferably from one-half to one-third of the thickness of the central portion of the inner endwall body 33.

It is noted that the portion of the inner endwall body 33 in which the digging area 34 is formed becomes an inter-nozzle thin-walled area. Stated another way, the inter-nozzle thin-walled area has a radial thickness equal to or more than half of the depth of the digging area 34.

In this manner, forming the digging area 34 enables efficient cooling of the central portion of the inner endwall body 33.

Further, in the inner endwall body 33, cooling channels 36 (upstream cooling channel) are formed in a range from the front end portion of the inner endwall body 33 to the base portion between the inner endwall body 33 and the upstream connection portion 31 in order to cool the range. Stated another way, the inner endwall body 33 has the cooling channels 36 extending in a range from the front end portion of the inner endwall body 33 to the base portion between the inner endwall body 33 and the upstream connection portion 31 in order to cool the range.

A plurality of cooling channels 36 (e.g., 30 to 50 cooling channels) are formed in the circumferential direction, and several cooling channels 36 (e.g., 10 to 20 cooling channels) of the plurality of cooling channels 36 are located in a circumferentially central portion and connected between the upstream connection portion 31 and the downstream connection portion 32.

Cooling air is introduced from the front end portion of the inner endwall body 33, and then directed to the base portion between the inner endwall body 33 and the upstream connection portion 31. The cooling air thus directed is injected into the digging area 34 through the impingement cooling plate 35.

Thereby, the cooling air, which has cooled the range from the front end portion of the inner endwall body 33 to the base portion between the inner endwall body 33 and the upstream connection portion 31, is used to cool the central portion of the inner endwall body 33.

In the inner endwall body 33, cooling channels 37 (downstream cooling channels) are also formed on the downstream side of the downstream connection portion 32 to cool this downstream side. Stated another way, the inner endwall body 33 has the cooling channels 37 formed on the downstream side of the downstream connection portion 32 to cool this downstream side.

A plurality of cooling channels 37 (e.g., 10 to 20 cooling channels) are formed in the circumferential direction, and in a range from a side face (downstream side face) of the digging area 34 to the rear end portion of the inner endwall body 33.

Thereby, the cooling air, which has cooled the central portion of the inner endwall body 33, is used to cool the inner endwall body 33 on the downstream side of the downstream connection portion 32. That is, the cooling air used for impingement cooling flows downstream in the horizontal direction to cool the inner endwall body 33 on the downstream side of the downstream connection portion 32, followed by being discharged.

In this manner, according to the examples, the inner endwall body 33, that is, the gas turbine nozzle 10 can be efficiently cooled by reusing the cooling air without an increase in the cooling air. Further, according to the examples, the inter-nozzle cooling and the downstream cooling can be provided efficiently by use of the same cooling air, leading to a reduction in cooling air.

The installation position of the impingement cooling plate 35 illustrated in the example will now be described schematically.

FIG. 5 is an explanatory diagram schematically illustrating an installation position of the impingement cooling plate 35 according to the examples.

The gas turbine nozzle 10 illustrated in the example has the integrated nozzle structure, and thus two nozzles 1 are formed between the inner endwall 3 and the outer endwall 2.

Therefore, in the example, the impingement cooling plate 35 is placed between the two nozzles 1 as illustrated in FIG. 5. That is, the digging area 34 is also formed between the two nozzles 1.

This provides uniform cooling between two nozzles 1 without being affected by pressure gradient on the gas path side, thus enabling an efficient reduction in metal temperature between the two nozzles 1.

Also, the digging area 34 and the impingement cooling plate 35 are preferably formed in a parallelogram shape.

In the gas turbine nozzle 10 according to the example, the rear edge portions of two nozzles 1 are offset in the circumferential direction with respect to the axis. Stated another way, the rear edge portions of two nozzles 1 are formed to be inclined in the circumferential direction with respect to the rear edge portion of the inner endwall 3.

Because of this, by forming the digging area 34 and the impingement cooling plate 35 in a parallelogram shape, further uniform cooling is provided between two nozzles 1. The cooling air is efficiently used to cool the inner endwall body 33, that is, the gas turbine nozzle 10 with efficiency.

In this manner, the gas turbine nozzle 10 according to the example includes two nozzles 1 formed integrally through the inner endwall 3 and the outer endwall 2. The inner endwall 2 has: the upstream connection portion 31 that extends radially inward and is connected to the inner turbine diaphragm 30; the downstream connection portion 32 that is located downstream from the upstream connection portion 31, extends radially inward, and is connected to the inner turbine diaphragm 30; and the inner endwall body 33 that extends from upstream toward downstream and on which the upstream connection portion 31 and the downstream connection portion 32 are formed.

The inner endwall body 33 has the digging area 34 dug radially outward in a position between the upstream connection portion 31 and the downstream connection portion 32. The impingement cooling plate 35 is installed on the surface of the digging area 34.

According to the example, it is possible to provide the gas turbine nozzle 10 using the impingement cooling plate 35 and efficiently using cooling air.

It should be understood that the present invention is not limited to the above examples and is intended to embrace various modifications. The above examples have been described in detail for the purpose of explaining the present invention clearly, and the present invention is not necessarily limited to including all the components and configurations described above.

### REFERENCE SIGNS LIST

1 . . . Nozzle
2 . . . Outer endwall
3 . . . Inner endwall
10 . . . Gas turbine nozzle
20 . . . Gas turbine bucket
21 . . . Upstream side hook
22 . . . Downstream side hook
23 . . . Outer endwall body
30 . . . Inner turbine diaphragm
31 . . . Upstream connection portion
32 . . . Downstream connection portion
33 . . . Inner endwall body
34 . . . Digging area
35 . . . Impingement cooling plate
36 . . . Cooling channel
37 . . . Cooling channel
40 . . . Outer turbine diaphragm
100 . . . Gas turbine

What is claimed is:

1. A gas turbine nozzle with nozzles formed integrally through an inner endwall and an outer endwall,
wherein the inner endwall has an upstream connection portion, a downstream connection portion, and an inner endwall body, the upstream connection portion extending radially inward and being connected to an inner turbine diaphragm, the downstream connection portion being located downstream from the upstream connection portion, extending radially inward and being connected to the inner turbine diaphragm, and the inner endwall body extending from upstream toward downstream and the upstream connection portion and the downstream connection portion being formed on the inner endwall body, and
the inner endwall body has a digging area that is dug radially outward in a position between the upstream connection portion and the downstream connection portion, and an impingement cooling plate is installed on a surface of the digging area.

2. The gas turbine nozzle according to claim 1, wherein the gas turbine nozzle has an integrated nozzle structure in which two of the nozzles are formed integrally through the inner endwall and the outer endwall.

3. The gas turbine nozzle according to claim 2, wherein the digging area is formed between two of the nozzles.

4. The gas turbine nozzle according to claim 2, wherein the digging area has a radial depth that has a value ranging from one-half to one-third of a thickness of a central portion of the inner endwall body.

5. The gas turbine nozzle according to claim 2, wherein the inner endwall body has one or more cooling channels to cool a range from a front end portion of the inner endwall body to a base portion of the upstream connection portion.

6. The gas turbine nozzle according to claim 2, wherein the inner endwall body has one or more cooling channels to cool a range downstream from the downstream connection portion.

7. The gas turbine nozzle according to claim 6, wherein the one or more cooling channels are formed in a range from a side face of the digging area to a rear end portion of the inner endwall body.
